(19) United States
(12) Patent Application Publication
(10) Pub. No.: US 2014/0071262 A1
(43) Pub. Date: Mar. 13, 2014

(54) IMAGE ACQUISITION APPARATUS AND IMAGE ACQUISITION SYSTEM

(71) Applicant: CANON KABUSHIKI KAISHA, TOKYO (JP)

(72) Inventor: Yuji Katashiba, Kawasaki-shi (JP)

(73) Assignee: CANON KABUSHIKI KAISHA, TOKYO (JP)

(21) Appl. No.: 14/022,927

(22) Filed: Sep. 10, 2013

(30) Foreign Application Priority Data
Sep. 12, 2012 (JP) 2012-200302

(51) Int. Cl. H04N 7/18

(52) U.S. Cl. CPC H04N 7/18
USPC 348/79

(57) ABSTRACT

An image acquisition apparatus includes: an imaging optical system configured to capture an image of an object; a plurality of re-imaging optical systems configured to re-image the object imaged by the imaging optical system; a reflecting optical system arranged on an optical path between the imaging optical system and the plurality of re-imaging optical systems; and a plurality of image-pickup elements configured to capture an image of the object re-imaged by the plurality of re-imaging optical systems. At least one of the plurality of image pickup elements is arranged in a plane different from a plane in which other image pickup elements are arranged; and the plurality of image-pickup elements are respectively capable of changing at least one of the positions in the direction of an optical axes of the corresponding re-imaging optical systems and the inclinations with respect to the optical axes on the basis of shape information of the object.

### BACKGROUND OF THE INVENTION

1. Field of the Invention

The present invention relates to an image acquisition apparatus, which is preferable for, for example, an image acquisition system configured to acquire image data of a pathological specimen.

2. Description of the Related Art

Recently, in the field of pathology inspection, an image acquisition system that uses an image acquisition apparatus to acquire image data of a pathological specimen (sample) and to display the image of the sample on a screen in order to allow pathological observation attracts much attention. By using such an image acquisition system, simultaneous observation of a sample image by a plurality of observers, data sharing between the observer and a pathologist at a distant place, and the like are realized.

When observing a sample larger than a field of view of an objective lens of the image acquisition apparatus, an image of the entire sample can be acquired by imaging the sample partially while moving the apparatus step by step a plurality of times in the horizontal direction (step imaging), or by scanning the sample while moving either the sample or the apparatus with respect to each other. Furthermore, by arranging a plurality of image pickup elements two-dimensionally as described in Japanese Patent Laid-Open No. 2009-3016, different regions of the sample can be imaged simultaneously, so that a throughput of image acquisition may be improved.

When observing the sample, an objective optical system having a high resolution in a visible range is required. However, when a numerical aperture (NA) of the objective optical system is increased in order to achieve high resolution, the depth of focus is reduced. Therefore, when the sample has a convexo-concave surface in the depth direction, out-of-focus portions may be created on the surface of the sample. Therefore, a desirable image of the entire sample cannot be acquired.

International patent application publication WO2012056920A1 discloses an image acquisition apparatus which is capable of moving a plurality of image pickup elements on the basis of a surface shape of the sample. According to the image acquisition apparatus in WO2012056920A1, since an image pickup surface of the image pickup elements can be moved closer to an in-focus plane of the image of the sample even when the sample has a convexo-concave surface and hence the in-focus plane of the image of the sample also has concavities and convexities, a satisfactorily focused entire image of the sample can be obtained.

In the image acquisition apparatus disclosed in WO2012056920A1, it is necessary to provide an electric circuit for reading out data, a moving mechanism for moving the image pickup element, and a cooling mechanism for cooling the image pickup element for each of the plurality of image pickup elements. However, in the image acquisition apparatus, since the plurality of image pickup elements are arranged two-dimensionally in a field of view of the objective lens, spaces among the image pickup elements are small, and a complex configuration is required for providing a moving mechanism and a cooling mechanism for each of the image pickup elements.

### SUMMARY OF THE INVENTION

The present invention provides an image acquisition apparatus with a simple configuration that is capable of acquiring a preferable image data of an entire sample even when the sample has a convexo-concave surface in the depth direction.

In order to achieve the above described object, according to a first aspect of the invention, there is provided an image acquisition apparatus including: an imaging optical system configured to capture an image of an object; a plurality of re-imaging optical systems configured to re-image the object imaged by the imaging optical system; a reflecting optical system arranged on an optical path between the imaging optical system and the plurality of re-imaging optical systems; and a plurality of image-pickup elements configured to capture an image of the object re-imaged by the plurality of re-imaging optical systems, wherein at least one of the plurality of image pickup elements is arranged in a plane different from a plane in which other image pickup elements are arranged, and wherein the plurality of image-pickup elements are respectively capable of changing at least one of the positions in the direction of an optical axes of the corresponding re-imaging optical systems and the inclinations with respect to the optical axes on the basis of shape information of the object.

Further features of the present invention will become apparent from the following description of exemplary embodiments with reference to the attached drawings.

### BRIEF DESCRIPTION OF THE DRAWINGS

FIG. 1 is a schematic drawing illustrating a principal portion of an image acquisition system according to an embodiment of the invention.

FIG. 2 is a schematic drawing illustrating a principal portion of a drive unit of an image pickup element according to the embodiment of the invention.

FIG. 3A and FIG. 3B are views of a periphery of an objective optical system according to Example 1 of the invention.

FIG. 4A and FIG. 4B are views of a periphery of an objective optical system according to Example 2 of the invention.

FIG. 5A and FIG. 5B views of a principal portion of a periphery of an objective optical system according to Example 3 of the invention.

### DESCRIPTION OF THE EMBODIMENTS

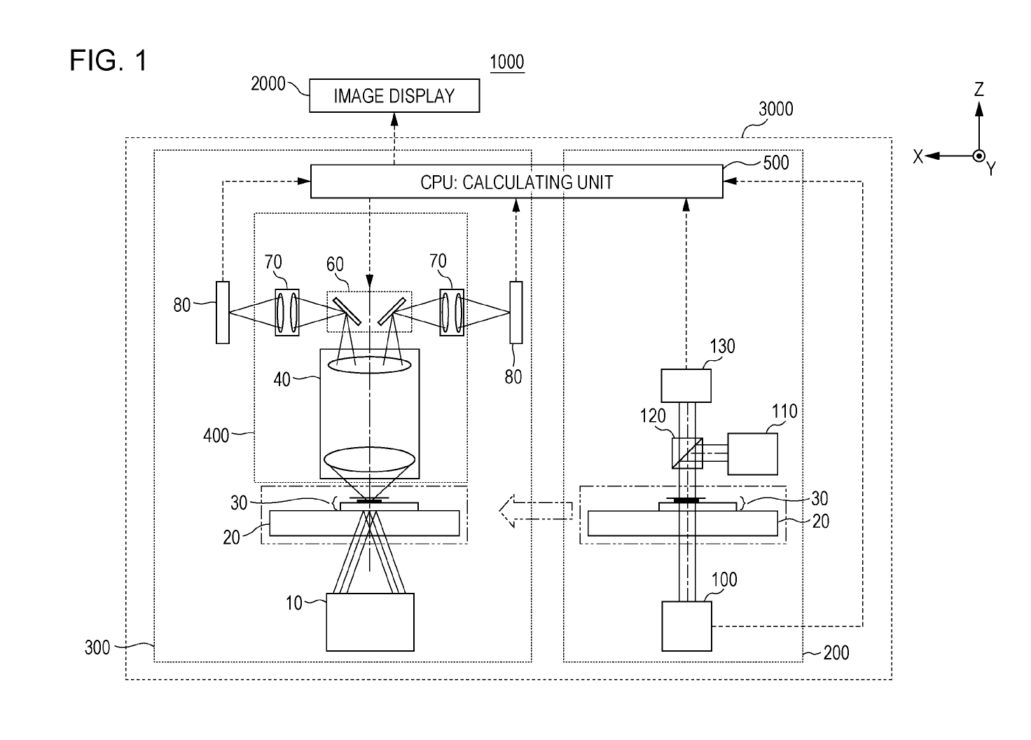

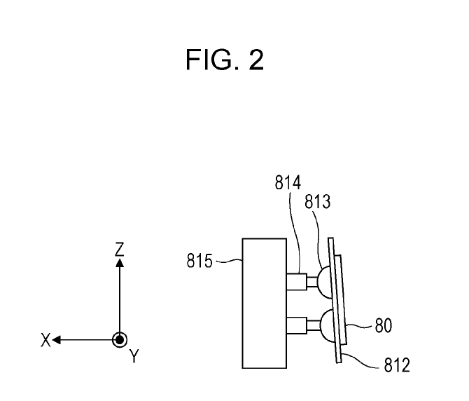

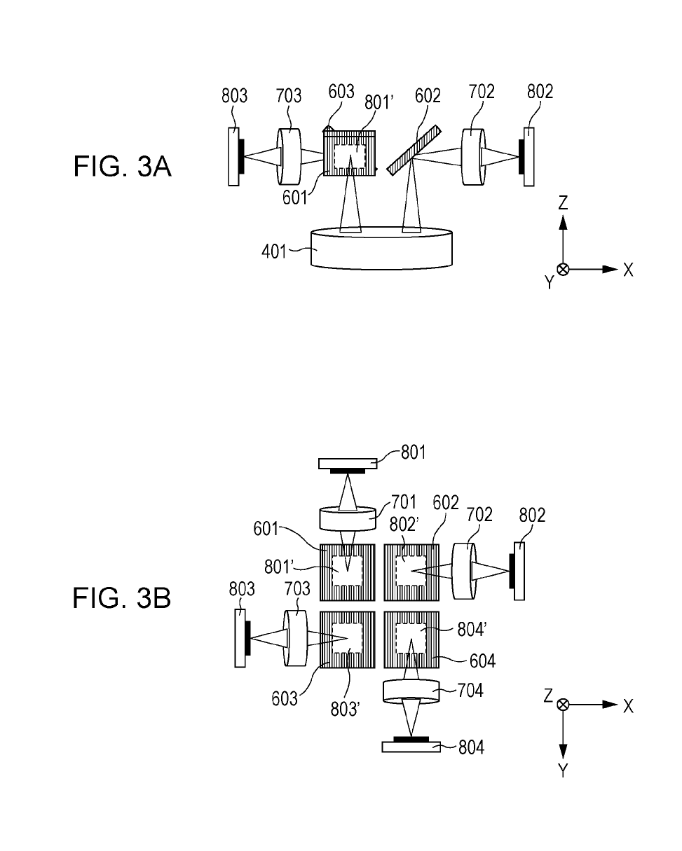

A first embodiment, according to the present invention, will be described below in detail with reference to FIGS. 1 and 2. Specific examples (additional embodiments) will be described with reference to FIGS. 3A to 5B.

An image acquisition apparatus according to the embodiment of the present invention is capable of adjusting a focus over the entire part of a sample by changing at least one of a position in the direction of an optical axis and an inclination with respect to the optical axis of a corresponding re-imaging optical system of each of a plurality of image pickup elements on the basis of shape information of the sample. At this time, with a configuration in which at least one of the plurality of image pickup elements within a plane different from planes in which other image pickup elements are located, spaces for providing moving mechanisms and cooling mechanisms with respect to the respective image pickup elements are secured. Embodiments of the image acquisition apparatus and an image acquisition system including the image acquisition apparatus will be described with reference to the drawings in detail. However, the present invention is not limited to the embodiments and examples described herein.

FIG. 1 is a schematic drawing of an image acquisition system 1000. The image acquisition system 1000 includes an image acquisition apparatus 3000 as a microscope configured to acquire an image of a sample, and an image display unit 2000 configured to display the acquired image. The image acquisition apparatus 3000 includes a stage 20 configured to hold a microscope slide 30 supporting the sample, a measuring unit 200 configured to acquire information of the sample, an image pickup unit 300 configured to capture an image of the sample, and a calculating unit 500 configured to perform control of the measuring unit 200 and the image pickup unit 300 and processing of the obtained image.

The measuring unit 200 includes a position measurement sensor 100, a measurement light source 110, a beam splitter 120, and a shape measuring sensor 130. The image pickup unit 300 includes an illumination optical system 10, an objective optical system 400 including an imaging optical system 40, a reflecting optical system (reflecting mirrors) 60 and a plurality of re-imaging optical systems 70, and a plurality of image pickup elements 80. In FIG. 1, in order to simplify the description, two re-imaging optical systems 70, and two image pickup elements 80 are illustrated. The stage 20 is configured to be movable between a position of measurement of the measuring unit 200 and an image pickup position of the image pickup unit 300 (a position of the imaging optical system 40).

Hereinafter, a procedure of the image acquisition of the image acquisition apparatus 3000 according to the embodiment will be described. In the embodiment, the direction of an optical axis of the imaging optical system 40 is defined as Z direction, the direction vertical to the paper surface is defined as Y direction, and the direction vertical to the Z direction and the Y direction is defined as X direction.

First, the microscope slide 30 supporting a sample is placed on the stage 20, and the stage 20 moves to the position of measurement of the measuring unit 200 in a state of holding the microscope slide 30. In the measuring unit 200, a light flux from the measurement light source 110 is deflected by the beam splitter 120, and the microscope slide 30 is irradiated with the deflected light flux. The light flux passed through the microscope slide 30 enters the position measurement sensor 100, where information on the size and the position of the sample on the microscope slide 30 in the XY direction is acquired. The position measurement sensor 100 may be a commercially available CCD camera.

In contrast, the light flux reflected from the microscope slide 30 passes through the beam splitter 120 and enters the shape measuring sensor 130. The position information of the sample surface in the microscope slide 30 in the Z direction at respective XY positions is measured by the shape measuring sensor 130 to acquire shape information of the sample. Examples of the shape measuring sensor 130 which can be used include commercially available Shack Hartman Sensor, an interferometer, and a line sensor. The measuring unit 200 is not limited to such a configuration and may perform measurement of the position and the size of the sample and measurement of the surface shape of the sample at different positions with different light sources.

Sample information (position, size and shape of the sample) acquired by the measuring unit 200 is transmitted to the calculating unit 500, and is stored in a memory (not shown) in the calculating unit 500. When acquisition of the sample information by the measuring unit 200 is terminated, the stage 20 holding the microscope slide 30 is moved from the position of measurement of the measuring unit 200 to the position of imaging of the image pickup unit 300.

In the image pickup unit 300, the microscope slide 30 is irradiated uniformly with a light flux emitted from the illumination optical system 10. The light flux to be emitted from the illumination optical system 10 may be visible light having a wavelength from 400 nm to 700 nm. Then, the imaging optical system 40 forms images of the sample in the vicinity of reflecting surfaces of the reflecting optical system 60 with the light flux passing through the sample on the microscope slide 30. The respective light fluxes forming an image of the sample reflected from the corresponding reflective surfaces of the reflecting optical system 60 and are deflected to the outside of an optical path of the imaging optical system 40, and are re-imaged on the image pickup surfaces of the corresponding image pickup elements 80 by the a plurality of the re-imaging optical systems 70, respectively. In the embodiment, enlarged images of the sample are formed on the image pickup surfaces of the image pickup elements 80 by configuring the objective optical system 400 as an enlargement system.

Each of the plurality of image pickup elements 80 has a configuration in which at least one of the position of the direction (X direction) of the optical axis of the corresponding re-imaging optical system 70 and the inclination of the same with respect to the optical axis can be changed. By controlling the position and the inclination of each of the plurality of image pickup elements 80 according to the shape information of the sample by the calculating unit 500, focus adjustment with respect to respective regions of the sample is achieved. In this manner, the image pickup unit 300 is capable of acquiring desirable focused image data over the entire sample by adjusting the position and the inclination of each of the plurality of image pickup elements 80 (described later in detail).

As described above, the image pickup unit 300 according to the embodiment employs a configuration in which the entire image of the sample formed by the imaging optical system 40 in the vicinity of the reflecting surfaces of the reflecting optical system 60 is partially re-imaged on the respective image pickup surfaces of the corresponding image pickup elements 80 by the plurality of re-imaging optical systems 70. This arrangement allows the image pickup unit to employ the configuration in which the plurality of light fluxes from the imaging optical system 40 are deflected in the different directions by the reflecting optical system 60 respectively. According to this configuration illustrated in FIG. 1, the plurality of image pickup elements 80 may be arranged respectively in planes different from each other dispersedly, the spaces for providing the moving mechanisms and the cooling mechanisms for the respective image pickup elements may be secured. In FIG. 1, the configuration in which all the image pickup elements are arranged in the planes different from each other is illustrated. However, the image pickup unit 300 according to the embodiment may only have to have a configuration including at least one image pickup element arranged in a plane different from a plane in which other image pickup elements are arranged. In this configuration, since the spaces for providing the moving mechanism and the cooling mechanism are increased in comparison with the configuration in which all the image pickup elements are arranged in the same plane, the effect of this invention is achieved.

The imaging optical system 40 is not limited to a configuration which images the sample only once, and a configuration in which a plurality of times of imaging are performed is also applicable. For example, the imaging optical system 40 may be used in a configuration in which an intermediate image is formed in the process of imaging a sample in the vicinity of the reflecting surfaces of the reflecting optical system 60 like the catadioptric system. In other words, in the objective optical system 400 of the embodiment, any number of times of imaging is applicable as long as the sample is imaged in the vicinity of the reflecting surfaces of the reflecting optical system 60 finally by the imaging optical system 40.

The plurality of image pickup elements 80 respectively image the samples re-imaged on the respective image pickup surfaces and the calculating unit 500 processes output information from the respective image pickup elements 80, whereby a plurality of image data are created. In order to acquire an entire image of a large sample which does not fit into the field of view of the objective optical system, additional image data is acquired by imaging the sample a plurality of times (step imaging) while moving the stage 20 in the horizontal direction or by imaging the sample while scanning. Then, a plurality of image data are combined by the calculating unit 500 to create a single image data. In the calculating unit 500, a variety of kinds of processing are performed according to the applications such as correction of aberration which is failed to be corrected by the objective optical system 400 in addition to the processing described above. The image data acquired by the image pickup unit 300 may be displayed on the image display unit 2000.

In the embodiment, the sample information is acquired by the measuring unit 200. However, the image acquisition apparatus 3000 may have a configuration without the measuring unit 200 and may be configured to transmit the sample information acquired by an external apparatus to the calculating unit 500. In this case, the microscope may include the image pickup unit 300 and the calculating unit 500. Alternatively, a control unit configured to perform control of the measuring unit 200 and the image pickup unit 300 and an image processing unit configured to perform processing of the obtained image may be provided separately instead of the calculating unit 500.

Subsequently, a method of adjusting the focus by changing at least one of the position and the inclination of each of the plurality of image pickup elements 80 will be described.

When acquiring an image of the sample by the image acquisition apparatus 3000, if the shape of the sample includes swellings (concavities and convexities in the Z direction), the positions where images of the respective regions of the sample are formed by the imaging optical system 40 (the imaging position) may change depending on the XY position of the sample. In other words, even when a flat sample image surface cannot be formed by the imaging optical system 40 and the image pickup elements 80 are arranged in a plane in the vicinity of the image surface of the sample, a focused image of the entire sample cannot be obtained.

Therefore, the image acquisition apparatus 3000 according to the embodiment employs a configuration in which the position and the inclination of each of the plurality of image pickup elements 80 can be changed for each of the image pickup elements 80 on the basis of the shape information of the sample. In other words, the image pickup surfaces of the respective image pickup element can be brought closer to the focused surface of the image of the sample by adjusting at least one of the position in the direction of the optical axis and the inclination with respect to the optical axis of the corresponding re-imaging optical system of each of the plurality of image pickup elements. Accordingly, the re-imaging position by each of the plurality of re-imaging optical systems 70 may be adjusted to match each of the image pickup surfaces of for each of the plurality of image pickup elements 80 corresponding thereto. When performing the step imaging, the focused image over the entire sample may be acquired by performing the above-described focus adjustment for each of the steps.

In the image acquisition apparatus 3000, with a configuration in which the plurality of light fluxes from the imaging optical system 40 are deflected respectively in different directions by the reflecting optical system 60, the plurality of image pickup elements 80 may be arranged dispersedly in planes different from each other. Accordingly, spatial room is formed between the image pickup elements and arrangement of a drive unit or a temperature adjusting mechanism may be achieved desirably for each of the plurality of image pickup elements 80.

Subsequently, the drive unit of the image pickup elements 80 will be described with reference to FIG. 2. The drive unit of the image pickup element 80 according to the embodiment includes a substrate 812, connecting members 813, cylinders 814, and a surface table 815. The image pickup element 80 is held by the substrate 812, and the cylinders 814 are connected via the connecting members 813 to the substrate 812. The cylinders 814 are provided on the surface table 815. In the embodiment, each of the image pickup elements 80 include three each of the connecting members 813 and the cylinders 814, and FIG. 2 illustrates only two of those on the near side. With this drive unit, the position in the X-axis direction and the inclination with respect to the X-axis of the image pickup element 80 may be adjusted by performing control to change lengths of the respective cylinders 814. The drive unit of the image pickup element 80 is not limited to the configuration illustrated in FIG. 2. For example, a linear stage, a rotation stage, a gonio stage which are commercially available may be used as a device for changing the position of the image pickup element 80.

From the description give above, the image acquisition apparatus 3000 according to the embodiment of this invention is capable of changing at least one of the position in the direction of the optical axis and the inclination with respect to the optical axis of the corresponding re-imaging optical system 70 of each of the plurality of image pickup elements 80 on the basis of the shape information of the sample. At this time, by employing a configuration in which the plurality of light fluxes are deflected in directions different from each other by the reflecting optical system 60 the plurality of image pickup elements 80 may be arranged respectively in the different planes dispersedly, the spaces for providing the moving mechanisms and the cooling mechanisms for the respective image pickup elements may be secured. Therefore, the image acquisition apparatus 3000 according to the embodiment is capable of acquiring the preferable image data focused over the entire sample in a simple configuration.

The respective examples of the image acquisition apparatus 3000 of this invention will be described in detail.

### Example 1

FIGS. 3A and 3B show a schematic drawing of a principal portion of a periphery of an objective optical system provided in the image acquisition apparatus according to the Example 1 of this invention. FIG. 3A is a schematic drawing of the objective optical system viewed from −Y direction to +Y direction, and FIG. 3B is a schematic drawing of the objective optical system viewed from −Z direction to +Z direction. The objective optical system according to the Example 1 includes an imaging optical system 401, a reflecting optical system, and re-imaging optical systems 701 to 704, and the reflecting optical system includes a plurality of reflecting members 601 to 604. Ranges 801′ to 804′ illustrated by broken lines indicate ranges on the reflecting members 601 to 604 corresponding to light receiving area of respective image pickup elements 801 to 804. For the sake of convenience, illustration of the reflecting members, the re-imaging optical systems, and part of the image pickup element are omitted in the drawing of FIG. 3A, and illustration of the inclination of the respective reflecting members and the imaging optical system 401 are omitted in the drawing of FIG. 3B.

At this time, as illustrated in the drawing, the reflecting members 601 to 604 in the reflecting optical system are respectively arranged so as to deflect respective light fluxes from the imaging optical system 401 in the directions different from each other, and the plurality of image pickup elements 801 to 804 are arranged respectively on planes different from each other in a dispersed manner. Then, the light fluxes reflected respectively from the reflecting members 601 to 604 are re-imaged on the respective image pickup surfaces of the corresponding image pickup elements 801 to 804 respectively by the corresponding re-imaging optical systems 701 to 704. In this configuration, spatial room is formed between the respective image pickup elements and arrangement of a drive unit or a temperature adjusting mechanism may be achieved desirably for each of the plurality of image pickup elements 801 to 804.

An imaging operation by the image acquisition apparatus of the Example 1 will be described in detail. The respective light fluxes from the sample on the microscope slide 30 pass through the imaging optical system 401, and form images in the vicinity of the respective reflecting members 601 to 604. The light fluxes which form the image of the sample are reflected from the respective reflecting members 601 to 604, and are deflected to the outside of an optical path of the imaging optical system 401. The deflected light fluxes are respectively re-imaged on the respective image pickup surfaces of the image pickup elements 801 to 804 respectively by the re-imaging optical systems 701 to 704.

At this time, focus adjustment is performed so that the images of the sample re-imaged respectively by the re-imaging optical systems 701 to 704 match the respective image pickup surfaces of the image pickup elements 801 to 804. More specifically, the drive units, not illustrated, are controlled by a calculating unit, and at least one of the positions in the directions of respective optical axes and inclinations with respect to the optical axes of the corresponding re-imaging optical systems 701 to 704 of the respective image pickup elements 801 to 804 is adjusted on the basis of the shape information of the sample. Accordingly, the image data focused at the respective image pickup elements 801 to 804 may be obtained.

According to the image acquisition apparatus of the Example 1, with the arrangement of the plurality of image pickup elements 801 to 804, the image data focused over a wider region is obtained by one-time imaging. However, when regions which cannot be imaged by the one-time imaging by the image pickup elements 801 to 804 (gaps among the ranges 801′ to 804′) are generated, gaps are also generated in the acquired image data. Therefore, in the Example 1, the position of a stage (not illustrated) configured to hold the sample is moved in the XY direction so as to fill the regions which cannot be imaged to image while stepping. In this case, at least one of the positions and the inclinations of the image pickup elements 801 to 804 is changed into different positions or inclinations from one step to another on the basis of the shape information of the sample. Then, by combining the image data acquired at the respective steps by the calculating unit 500, one image data focused over the entire sample and having no clearance may be created.

### Example 2

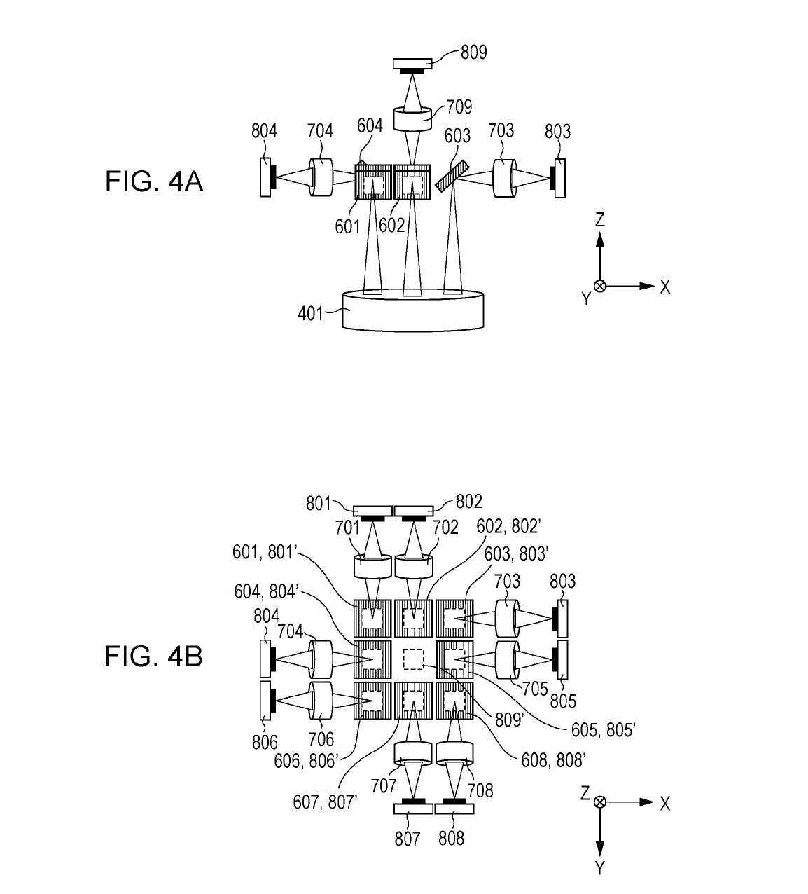

FIGS. 4A and 4B show a schematic drawing of a principal portion of a periphery of an objective optical system provided in the image acquisition apparatus according to Example 2 of this invention. FIG. 4A is a schematic drawing of the objective optical system viewed from −Y direction to +Y direction, and FIG. 4B is a schematic drawing of the objective optical system viewed from −Z direction to +Z direction. The components same as or equivalent to the Example 1 are denoted by the same reference signs, and the description thereof is simplified or omitted. The objective optical system according to Example 2 includes the imaging optical system 401, the reflecting optical system, and re-imaging optical systems 701 to 709, and the reflecting optical system includes a plurality of reflecting members 601 to 608.

The image acquisition apparatus of Example 2 forms images respectively on image pickup elements 801 to 808 by the objective optical system thereof, and the numbers of the reflecting members, the re-imaging optical systems, and the image pickup elements are respectively larger than those of the Example 1. The range 809′ is a range corresponding to the light-receiving region of the image pickup element 809 at an opening portion surrounded by the reflecting members 601 to 608. The image pickup element 809 is arranged at a position where the light flux emitted from the imaging optical system 401 and passing through the opening portion can be received, and the reflecting members 601 to 608 are arranged at a portion other than on the optical path of the light flux passing through the opening portion.

At this time, the reflecting members 601 to 608 are respectively arranged so as to deflect the respective light fluxes from the imaging optical system 401 in a plurality of directions, and the plurality of image pickup elements 801 to 809 are arranged respectively on a plurality of planes different from each other in a dispersed manner. Then, the light fluxes reflected respectively from the reflecting members 601 to 608 are re-imaged on the respective image pickup surfaces of the corresponding image pickup elements 801 to 808 respectively by the corresponding re-imaging optical systems 701 to 708. In this configuration, spatial room is formed between the respective image pickup elements and arrangement of a drive unit or a temperature adjusting mechanism may be achieved desirably for each of the plurality of image pickup elements 801 to 809.

An imaging operation by the image acquisition apparatus of Example 2 will be described in detail. The respective light fluxes entering the range 801′ to 808′ from among the respective light fluxes from the sample on the microscope slide 30 pass through the imaging optical system 401, and form images in the vicinity of the respective reflecting members 601 to 608. The light flux entering the range 809′ from among the respective light fluxes from the sample focused in the vicinity of the opening surrounded by the respective reflecting members 601 to 608. At this time, at least one of the position and the inclination of the stage (not illustrated) that holds the sample is adjusted so that the light flux entering the range 809′ is focused on the image pickup surface of the image pickup element 809. In Example 2, at least one of the position of the direction (Z direction) of the optical axis of the imaging optical system 401 and the inclination of the same with respect to the optical axis of the stage is adjusted. Here, the optimal inclination of the stage is obtained by least-square method or the like on the basis of the shape of the sample acquired by the measuring unit 200.

Then, the stage is fixed to this position, and at least one of the positions in the directions of respective optical axes and inclinations with respect to the optical axes of the corresponding re-imaging optical systems 701 to 708 is adjusted on the basis of the shape information of the sample in respectively in the image pickup elements 801 to 808. Accordingly, adjustment is performed so that the images of the sample re-imaged by the re-imaging optical systems 701 to 708 match the respective image pickup surfaces of the image pickup elements 801 to 808.

As described thus far, according to the image acquisition apparatus of Example 2, with the arrangement of the plurality of image pickup elements 801 to 809, the image data focused over a wider region is obtained by one-time imaging in comparison with the Example 1. For the region in which the imaging cannot be performed with one-time imaging, the position of the stage configured to hold the sample is moved in the XY direction in the same manner as the Example 1 to image while stepping, so that the image data of the entire sample can be acquired.

### Example 3

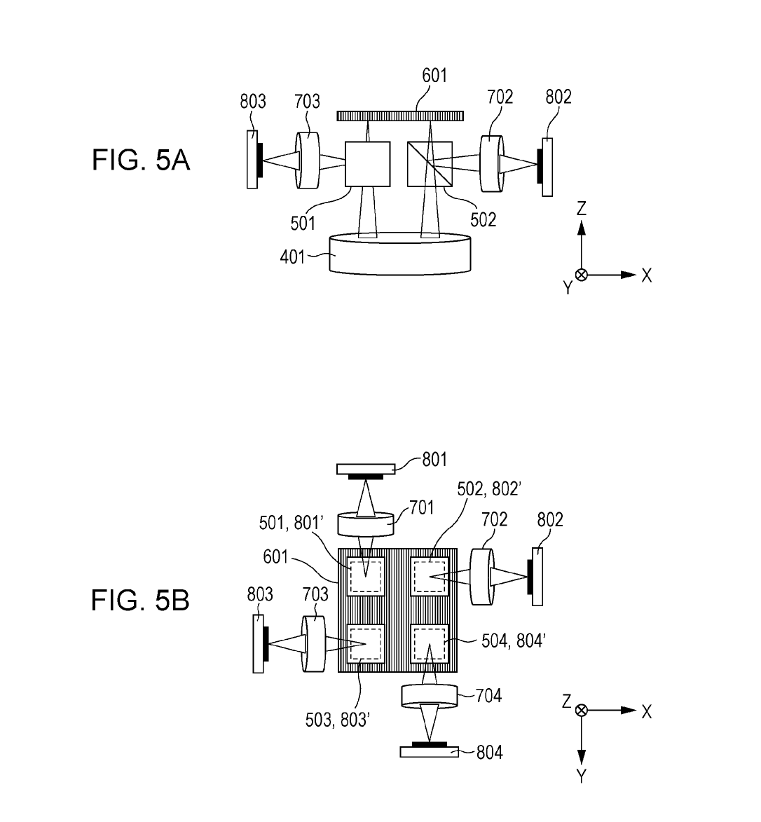

FIGS. 5A and 5B show a schematic drawing of a principal portion of a periphery of an objective optical system provided in the image acquisition apparatus according to Example 3 of this invention. FIG. 5A is a schematic drawing of the objective optical system viewed from −Y direction to +Y direction, and FIG. 5B is a schematic drawing of the objective optical system viewed from −Z direction to +Z direction. The components same as or equivalent to the Example 1 are denoted by the same reference signs, and the description thereof is simplified or omitted. The objective optical system according to Example 3 includes the imaging optical system 401, beam splitters 501 to 504, a reflecting optical system 601, and the re-imaging optical systems 701 to 704. The ranges 801′ to 804′ illustrated by broken lines indicate ranges on the reflecting optical system 601 corresponding to the light receiving areas of the respective image pickup elements 801 to 804. The reflecting optical system 601 of Example 3 is formed with a single reflecting member unlike the Example 1.

The objective optical system according to Example 3 includes the beam splitters 501 to 504 arranged on an optical path between the imaging optical system 401 and the reflecting optical system 601 and deflect the light flux reflected by the reflecting optical system 601 to the outside of the optical path of the imaging optical system 401. By providing the beam splitters 501 to 504, a distance between the imaging optical system 401 and the reflecting optical system 601 (back focus of the imaging optical system 401) may be reduced. The respective re-imaging optical systems 701 to 704 are arranged so as to condense the light fluxes deflected respectively by the beam splitters 501 to 504 onto the respective image pickup surfaces of the corresponding image pickup elements 801 to 804. Here, the respective beam splitters 501 to 504 are arranged so as to deflect the respective light fluxes from the imaging optical system 401 in the directions different from each other, and the plurality of image pickup elements 801 to 804 are arranged respectively on planes different from each other in a dispersed manner. In this configuration, spatial room is formed between the respective image pickup elements and arrangement of a drive unit or a temperature adjusting mechanism may be achieved desirably for each of the image pickup elements 801 to 804.

An imaging operation by the image acquisition apparatus of Example 3 will be described in detail. The respective light fluxes from the sample on the microscope slide 30 enter the imaging optical system 401, and form images in the vicinity of the reflecting optical system 601 via the respective beam splitters 501 to 504. Then, the light fluxes forming the image of the sample are reflected by the reflecting optical system 601, pass through the respective beam splitters 501 to 504 again, and are deflected to the outside of the optical path of the imaging optical system 401. The deflected light fluxes are respectively re-imaged on the respective image pickup surfaces of the image pickup elements 801 to 804 respectively by the re-imaging optical systems 701 to 704.

In the same manner as the Example 1, at least one of the positions in the directions of respective optical axes and inclinations with respect to the optical axes of the corresponding re-imaging optical systems 701 to 704 is adjusted in respectively in the image pickup elements 801 to 804. Accordingly, the image data focused at the respective image pickup elements 801 to 804 may be acquired. For the region in which the imaging cannot be performed with one-time imaging, the position of the stage configured to hold the sample is moved in the XY direction in the same manner as the Example 1 to image while stepping, so that the image data of the entire sample can be acquired.

### Other Examples

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, in Example 2, the images of the light fluxes formed at the opening surrounded by the respective reflecting members are re-imaged on the image pickup surface of one image pickup element by the re-imaging optical system. However, a configuration in which the image pickup element is arranged at a position of the opening may also be applied. By arranging the image pickup element at the position of the opening, the image can be formed on the image pickup surface of the image pickup element even without providing the re-imaging optical system. In Example 2, the focusing is performed by adjusting the position of the stage that holds the sample with respect to the image pickup element 809 configured to receive the light flux without the reflecting member. However, the focusing may be achieved by driving the image pickup element 809 without driving the stage.

In Example 3, by providing the opening on the reflecting optical system formed with the one reflecting member, a configuration in which the one image pickup element configured to receive the light flux without the reflecting optical system as Example 2 is achieved. At this time, the beam splitter needs only to be arranged on out of the optical path of the light flux passing through the opening, the number of beam splitters may be reduced. When employing such a configuration, by arranging a parallel plate glass on the optical path of the light flux passing through the opening, the lengths of the light flux passing through the opening and other beams passing through the beam splitter may be equalized. In contrast, the beam splitter may be arranged so as to be shifted in the direction of the optical axis of the imaging optical system, whereby the plurality of light fluxes may be guided to the corresponding image pickup elements desirably without forming the opening in the reflecting optical system.

The number and the arrangement of the image pickup elements provided in the image acquisition apparatus may be determined adequately in accordance with the shape and the size of the sample. Therefore, by arranging the re-imaging optical system and the reflecting member so as to align with the arrangement of the respective image pickup elements, the focus adjustment is performed in the same manner as the respective examples described above. Here, a configuration in which one image pickup element configured to receive the light flux without the reflecting member is provided as in Example 2 irrespective of the number of the image pickup element may be employed. In this case, the focus may be adjusted on all the image pickup elements by adjusting the inclinations of the reflecting members corresponding to other image pickup elements with reference to the position focused on the image pickup surface of the one image pickup element.

In the respective examples, although the step imaging is performed when capturing the image of the entire sample, this invention may be applied to a configuration in which the entire part of the sample is scanned. Also, the image acquisition apparatus according to this invention is not limited to the microscope configured to observe the sample in an enlarged state by configuring the objective optical system as the enlargement system. For example, the image acquisition apparatus is also applicable as an inspection apparatus configured to perform an appearance inspection (inspection of attachment of foreign objects, or scratches) of the substrate or the like.

In referring to the description, specific details are set forth in order to provide a thorough understanding of the examples disclosed. In other instances, well-known methods, procedures, components, and circuits have not been described in detail as not to unnecessarily lengthen the present disclosure. Some embodiments or diagrams of the present invention may be practiced on a computer system that includes, in general, one or a plurality of processors for processing information and instructions, random access (volatile) memory (RAM) for storing information and instructions, read-only (non-volatile) memory (ROM) for storing static information and instructions, a non-transitory data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

As will be appreciated by those of ordinary skill in the art, certain aspects of the present examples may be embodied as a system, a method, or a computer program product. Accordingly, some examples may take the form of an entirely hardware embodiment, or an embodiment combining software and hardware aspects that may all generally be referred herein as a “unit”, “circuit”, “module” or “system”. Further, some embodiments may take the form of a computer program product embodied in any non-transitory tangible computer-readable medium having computer-usable program code stored therein. For example, some embodiments described below with reference to flowchart illustrations and/or block diagrams of methods, apparatus (systems), and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in a flowchart and/or block diagram.

This application claims the benefit of Japanese Patent Application No. 2012-200302 filed Sep. 12, 2012, which is hereby incorporated by reference herein in its entirety.

What is claimed is:

1. An image acquisition apparatus comprising:
an imaging optical system configured to capture an image of an object;
a plurality of re-imaging optical systems configured to re-image the object imaged by the imaging optical system;
a reflecting optical system arranged on an optical path between the imaging optical system and the plurality of re-imaging optical systems; and
a plurality of image-pickup elements configured to capture an image of the object re-imaged by the plurality of re-imaging optical systems,
wherein at least one of the plurality of image pickup elements is arranged in a plane different from a plane in which other image pickup elements are arranged, and
wherein the plurality of image-pickup elements are respectively capable of changing at least one of the positions in the direction of an optical axes of the corresponding re-imaging optical systems and the inclinations with respect to the optical axes on the basis of shape information of the object.

2. The image acquisition apparatus according to claim 1, further comprising a drive unit configured to drive each of the plurality of image pickup elements on the basis of the shape information of the object.

3. The image acquisition apparatus according to claim 1, further comprising a measuring unit configured to acquire the shape information of the object.

4. The image acquisition apparatus according to claim 1, wherein the reflecting optical system includes a plurality of reflecting members arranged on each optical path between the imaging optical system and the plurality of re-imaging optical systems.

5. The image acquisition apparatus according to claim 4, wherein at least one of the plurality of reflecting members is arranged so as to reflect a light flux from the imaging optical system in a direction different from a direction in which other reflecting members reflect the light fluxes.

6. The image acquisition apparatus according to claim 1, wherein the plurality of image pickup elements includes an image pickup element arranged at a position where a light flux emitted from the imaging optical system without passing through the reflecting optical system can be received.

7. The image acquisition apparatus according to claim 1, further comprising:
a plurality of beam splitters arranged on the optical path between the imaging optical system and the reflecting optical system and configured to deflect the light flux reflected by the reflecting optical system to the outside of the optical path of the imaging optical system,
wherein each of the plurality of re-imaging optical systems is arranged so as to condense the light fluxes deflected by the plurality of beam splitters onto respective image pickup surfaces of the corresponding plurality of image pickup elements.

8. The image acquisition apparatus according to claim 7, wherein at least one of the plurality of beam splitters deflects the light flux in a direction different from the directions in which other beam splitters deflect the light fluxes.

9. The image acquisition apparatus according to claim 7, wherein at least one of the plurality of beam splitters is arranged at a position different from other beam splitters in the direction of the optical axis of the imaging optical system.

10. The image acquisition apparatus according to claim 7, wherein an opening is provided in the reflecting optical system, and
the plurality of beam splitters are arranged at positions other than the optical path of the light flux passing through the opening.

11. The image acquisition apparatus according to claim 1, wherein the image acquisition apparatus is a microscope, and forms an enlargement system with the image optical system and the plurality of re-imaging optical systems.

12. An image acquisition system comprising:
an image acquisition apparatus including:
an imaging optical system configured to capture an image of an object;
a plurality of re-imaging optical systems configured to re-image the object imaged by the imaging optical system;
a reflecting optical system arranged on an optical path between the imaging optical system and the plurality of re-imaging optical systems; and
a plurality of image-pickup elements configured to capture an image of the object re-imaged by the plurality of re-imaging optical systems,
wherein at least one of the plurality of image pickup elements is arranged in a plane different from a plane in which other image pickup elements are arranged,
and
wherein the plurality of image-pickup elements are respectively capable of changing at least one of the positions in the direction of an optical axes of the corresponding re-imaging optical systems and the inclinations with respect to the optical axes on the basis of shape information of the object, and
an image display unit configured to display image data of the object acquired by the image acquisition apparatus.
